(19) United States
(12) Patent Application Publication
(10) Pub. No.: US 2006/0072097 A1
(43) Pub. Date: Apr. 6, 2006

(54) Method for characterization of the illuminator in a lithographic system

(76) Inventors: Franz X. Zach, Santa Clara, CA (US); Bo Wu, San Jose, CA (US); Abdurrahman Sezginer, Los Gatos, CA (US)

Correspondence Address: SMITH-HILL AND BEDELL, P.C., 16100 NW CORNELL ROAD, SUITE 220, BEAVERTON, OR, 97006, US

(21) Appl. No.: 10/960,357

(22) Filed: Oct. 6, 2004

(51) Int. Cl. G03B 27/72

(52) U.S. Cl. 355/69; 355/71; 355/53

(57) ABSTRACT

Pupil intensity distribution of an imaging system is measured by exposing an image field of a radiation detector with a bright feature, positioning the detector at a distance away from the image plane, and exposing the image field of the detector with a bright feature, resulting in a cumulative exposure of the image field of the detector from the two exposures. A characteristic of a spatial pattern in the cumulative exposure of the image field of the detector is then determined.

### CROSS-REFERENCE TO RELATED APPLICATIONS

Subject matter disclosed in this application might be considered to be related to subject matter disclosed in co-pending patent application Ser. No. 10/861,170 filed Jun. 4, 2004 and co-pending patent application Ser. No. 10/933,090 filed Sep. 1, 2004, both of which are assigned to the assignee of the present application and the entire disclosure of each of which is hereby incorporated by reference herein for all purposes.

### BACKGROUND OF THE INVENTION

This invention relates to a method of characterizing lithography projection equipment used in manufacturing of integrated circuits.

Referring to FIG. 1, a conventional optical lithographic scanner system, for image-wise exposure of a coating of resist on a semiconductor wafer, includes an extended light source for emitting a beam of actinic radiation. The illuminator optics project the light from the extended source onto an exposure mask (also called a reticle) that defines a pattern of features that are to be transferred from the mask to the resist coating. Apertures inserted at the extended light source define the angular light distribution of the illuminator. The light passes through the mask, which is shown as having a single opaque element in a transparent field. The projection optics create an image of the mask pattern on the resist coating. Upon exposure to radiation chemical reactions are initiated within the resist that ultimately change the resist solubility in aqueous solutions. In order to complete the reactions initiated during exposure elevated temperatures are required and therefore the wafer is placed on a bakeplate for a certain amount of time. This process step is commonly referred to as post exposure bake. The solubility determines the speed with which resist is removed if covered by an aqueous solution (typically a solution of TMAH in water). The process of removing resist in the areas that have been exposed to light is referred to as resist development. High solubility corresponds to a fast development rate (i.e. removal rate). The solubility change depends in a highly nonlinear, approximately step-like fashion on the radiation dose. There are two categories of dose dependencies. For example there are resists which have very low to negligible development rates at low doses and their development rate increases with increasing dose. Such resists are referred to as positive resists. The inverse relationship, high development rate at low doses and small development rate at large doses, is found in negative resists. Resist thickness is a variable that can easily be measured with existing equipment in the semiconductor manufacturing line. Therefore a common way of representing the dependency of the development process on exposure dose in graphic form is to plot the remaining resist thickness as a function of exposure time given a fixed initial resist thickness and time of development. Even more easily detectable than the resist thickness is the lowest dose at which the resist is completely removed from the wafer. The corresponding dose is referred to as ‘dose to clear’ (D₀). The value of Do is not a fixed property of the resist, rather it depends on a variety of process parameters, some of which have already been mentioned (resist thickness, develop time). Other parameters are for example the temperature of the post exposure bake, time delay between exposure and bake as well as developer concentration and temperature. These parameter may vary across the wafer and thus lead to across wafer variations of the dose to clear D₀. A common cause of such variations is nonuniform temperature distributions across the post exposure bake plate.

After the development process, a pattern of resist features that corresponds to the pattern of opaque features of the exposure mask (in the case of a positive resist) remain on the wafer. This resist pattern may then be transferred into the underlying substrate through various etch processes as areas covered by resist are not subject to the etch erosion.

FIG. 1 provides a schematic overview of an imaging system. Light from an extended light source is projected onto the reticle with the illuminator optics. The pattern created by those areas which block light and those which allow light to pass through the projection optics is imaged onto the resist pattern covering the wafer. The best image characterized by the highest fidelity of the imaged pattern to the original mask pattern exists only for a specific distance between projection optics and wafer and to a lesser degree for a small range around this distance. For other distances other characteristics of the imaging system may determine the pattern formed on the wafer and the pattern may not at all be reminiscent of the pattern on the mask.

The transfer of the complete mask image onto the wafer may be accomplished via one single exposure, in which case the full image area of the mask is uniformly illuminated at once. In this case the dose delivered to the wafer is controlled by opening a shutter for a certain amount of time. Alternatively, only a slit-shaped region of the mask is exposed at a time projecting an equivalent image on the wafer. Image transfer of the full mask image is accomplished through simultaneous, highly coordinated movement of both reticle and wafer stage, a process referred to as scanning. The dose delivered in this case is largely controlled via the speed of this scanning movement. The maximum area of the wafer that can be exposed in a single exposure is referred to herein as the exposure field. The exposure field corresponds to the area of the wafer that would be exposed in the event that the mask were completely clear, and its size and shape are therefore governed by the exposure tool. Generally, the exposure field is rectangular and the exposure tool is used to expose multiple exposure fields that are adjacent each other on a rectangular grid. Thus, to expose an entire wafer, in both imaging approaches once a first exposure field has been exposed the stage is stepped to a new position followed by the next field exposure. In normal operation each field on the wafer is only exposed once, however there are several applications where it is advantageous to expose a field more than once, in most cases with different masks. These techniques are called double exposure techniques. The exposure tool is not limited to exposing exposure fields that are in abutting relationship. For example, the stepping distance along the X or Y axis may exceed the size of the rectangular exposure field, in which case there will be guard strips between adjacent exposure fields, or the stepping distance along either or both axes may be less that the size of the rectangular exposure field, in which case the exposure fields would overlap.

The area of the wafer that is exposed by a bright feature of an exposure mask is referred herein as the image field. A mask may have several discrete bright features, in which case there are, correspondingly, several image fields on the wafer.

For modern lithography systems, controlling the characteristics of the illumination system has become an important parameter in the lithographic process setup. Modern illuminators not only achieve uniform illumination intensity across the mask, but they also provide control over the angular light distribution that impinges on each point of the reticle. Examples of such distributions are shown in FIG. 2, which depicts examples of conventional homogeneous and annular illumination. This figure represents common illumination patterns employed in lithographic systems. For example in conventional homogeneous illumination each point on the reticle field is illuminated with light up to a certain angle of incidence. Therefore if each ray of light passing through the reticle at a given point is drawn, the resulting shape is that of a cone as shown in FIG. 2. In the case of annular illumination, only light within a certain range of angles strikes the reticle. The corresponding representation therefore appears as a double cone. The limiting angles shown in these images are given as ratios referred to as the sigma value. Sigma is defined as the ratio between the sine of the angle on the illuminator and the numerical aperture NA (which in itself is the sine of an angle). The most common way of providing a graphical representation of the actual performance of an illuminator is to use the sine of the angle of incidence and the rotational angle in the plane, to identify a certain direction and plot the intensity delivered by the illuminator in this direction. The resulting graphs are 3D representations of the illuminator performance sometimes also referred to as ‘pupilograms’ or ‘pupil illumination’ as it describes the light distribution at the entrance pupil of the projection system in the case that there is no reticle present. This distribution will be referred to as intensity distribution of the illuminator, or illumination distribution for short. Knowledge of this distribution is of great significance as it plays a key role in determining the imaging performance of the projection system.

Given these distributions it is now apparent that a variety of other non-uniformities and non ideal illumination patterns are possible. For example, each one of the directions indicated in FIG. 2 may have different intensities associated with it resulting for example in non-radially symmetric distributions. As another example, the transition at the limiting angle may not be as sharp as implied in the figure and there may be a more gradual transition from zero intensity at some angle larger than the cutoff angle indicated in FIG. 2 to the desired intensity value at some angle smaller than the cutoff angle. Such imperfections lead to variations and non ideal behavior in the imaging performance of an exposure system. For example, asymmetric illumination patterns result in pattern asymmetries as a function of focus. The exact shape of the illuminator distribution also controls other important imaging characteristics such as the difference in resist linewidth between isolated and nested features and line end foreshortening.

Finally all these characteristics may vary from one point on the reticle, or exposure, field to another.

As a result, several techniques have been developed to characterize the illumination system. J. P. Kirk et al. “Pupil Illumination; in situ measurement of partial coherence”, Proc. SPIE Vol. 3334, 1998, p. 281-288 describes a technique for recording the illumination distribution. In this technique an obscuration (negative pinhole) is placed on the backside of a reticle. The image of such a feature is formed at a distance far away from the wafer plane. As a result the pattern formed on the wafer is representative of the illumination distribution rather than the shape of the obscuration. Several resist images at a series of exposure doses are recorded in resist and allow a reconstruction of the illumination distribution. Brunner et al., U.S. Pat. No. 6,048,651 discloses a modification of the general methodology using a fresnel zone target as the obscuration.

B. B. McArthur et al., U.S. Pat. No. 6,356,345 “In Situ Source Metrology Instrument and Methodology of Use” discloses a methodology for determining pupil illumination by providing a set of field points in the object plane together with an array of aperture planes at a sufficient distance from the reticle such as to provide an image of the illumination. In one of the best mode implementations the images are also recorded in resist.

Double exposure techniques have been employed in lithography and to some extent in scanner characterization. In particular we refer to the co-pending patent application Ser. No. 10/933,090 filed Sep. 1, 2004. In addition F. Zach et al. “Aberration Analysis using Reconstructed Aerial images of Isolated Contacts on Attenuated Phase shift masks” describe a double exposure method for determining aberrations of an exposure tool. In this publication images of a contact hole are superimposed onto a first, uniform exposure with a dose of less than dose to clear. Based on an analysis of the image intensity in the sidelobe of the main contact image, aberrations can be extracted.

### SUMMARY OF THE INVENTION

In accordance with one aspect of the preset invention there is provided a method of measuring pupil intensity distribution of an imaging system having an image plane, said method comprising providing a radiation detector, exposing an image field of the detector with a bright feature, positioning the detector at a distance away from the image plane, exposing the image field of the detector with a bright feature, resulting in a cumulative exposure of the image field of the detector from at least the exposing steps b and d, and determining a characteristic of a spatial pattern in the cumulative exposure of the image field of the detector.

In accordance with another aspect of the present invention there is provided a method of measuring pupil intensity distribution of an imaging system having an image plane, said method comprising providing a radiation detector that includes a resist that changes state of coverage upon exposure to radiation with a dose larger than D₀, positioning the detector at the image plane of the imaging system, exposing a first region of the detector to a radiation dose DB, wherein DB is less than D₀, positioning the detector at a predetermined distance away from the image plane, exposing a second region of the detector to a dose DP of radiation emanating from a bright feature of an exposure mask, wherein the first and second regions of the detector overlap, developing the resist detector, and determining a characteristic of a spatial pattern revealed by step f.

The object of the present invention is to characterize the intensity distribution of the illuminator in a lithographic system.

Preferred embodiments of the present invention provide methods of measuring the intensity distribution of an illuminator. The methodology uses a test mask and a photoresist detector that comprises a positive photoresist film deposited on a wafer.

In one embodiment the method consists of a first exposure where one or more features of the test mask form a reference image on the photoresist detector. On a second exposure, one or more features of the test mask produce an image characteristic of the illuminator. This is accomplished by placing the resist detector out of focus. The reference image provides a spatial reference mark required for the analysis of the illumination pattern.

In another embodiment, the intensity distribution of the illuminator is characterized by combining the exposure of a pinhole imaged in a far out of focus condition with a uniform exposure of an intensity below dose to clear.

With appropriate placement of the test features on the mask the pupil information may be obtained across the exposure field. This information may now be available to modify a layout in a location dependent manner given location dependent pupil information.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates the basic components of an exposure system. Radiation emanating from an extended light source passes through the illuminator optics which projects the light onto the mask. The image of the chrome pattern is formed if the mask plane is conjugate to the wafer plane (a condition called ‘in focus’).

FIG. 2 illustrates the angular distribution of light impinging on a single point in the mask for a conventional illumination pattern and an annular illumination pattern.

FIG. 3 schematically shows how an image representation of the pupil may be formed through a transparent pattern on the mask imaged at large off focus condition.

FIG. 4 shows images created by a pinhole at increasing distance of the resist detector to the best imaging condition (i.e. in focus condition). The images show how with increasing defocus the wafer pattern increasingly resembles the pupil illumination.

FIG. 5 shows the principle of the double exposure technique. The illuminator image is superimposed on a uniform exposure background thereby reducing the amount of light exposure dose necessary to reach the resist threshold.

FIGS. 6A, 6B and 6C show various configurations of a mask that may be used in preferred embodiments of the invention.

FIG. 7 shows a preferred embodiment of the invention whereby a reference mark is placed next to the image that represents the illuminator pattern.

### DETAILED DESCRIPTION

Characterization of the Illuminator Using a Double Exposure Technique

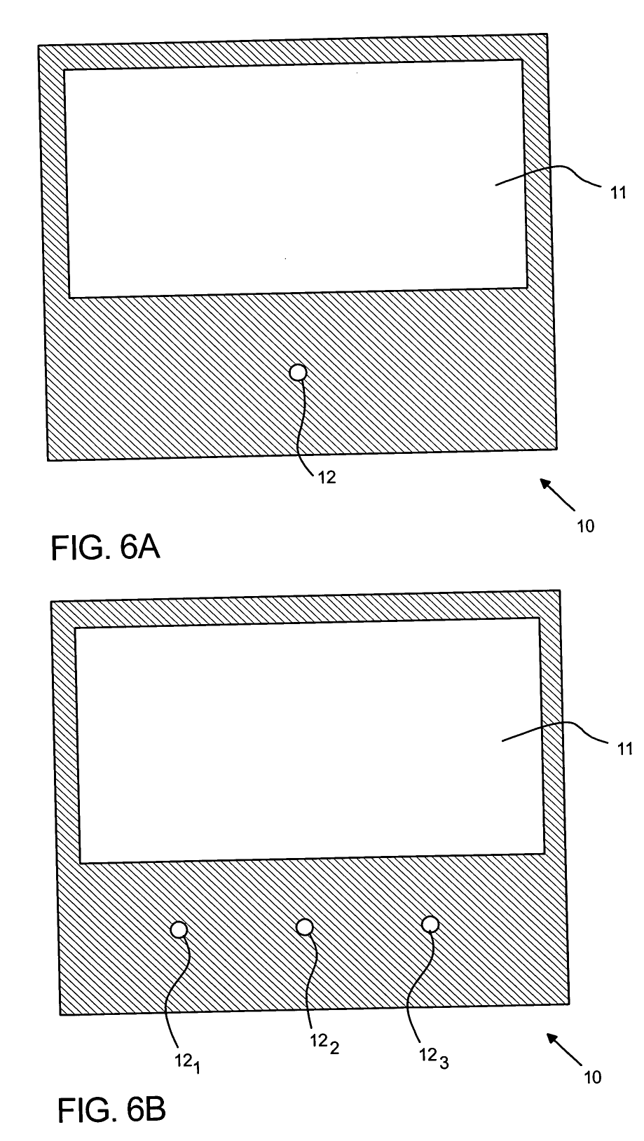

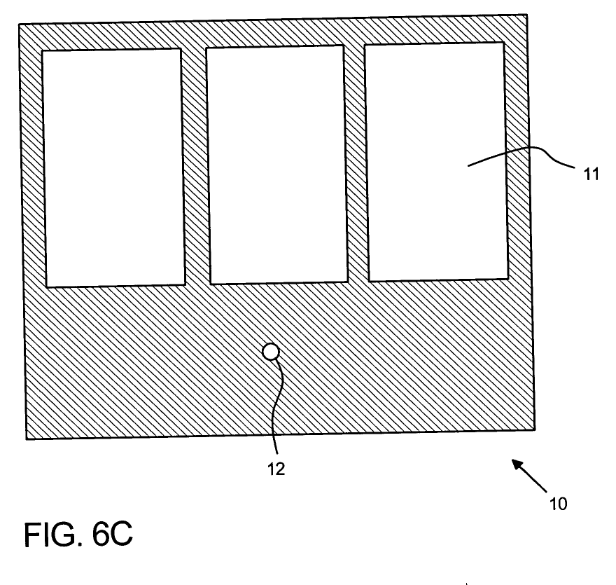

Referring to FIG. 6A, a test structure that may be used to characterize the intensity distribution of an illuminator by a double exposure method embodying the present invention comprises mask 10 that defines a large transparent window 11 and a smaller transparent opening 12 in an opaque field. Mask 10 is typically made by depositing a thin film of chromium on a fused silica plate and then etching the chromium to define window 11 and opening 12.

In a preferred implementation of the invention, the opening 12 is round and is more than one micrometer in diameter. The lower limit on the size of the opening is chosen such as to minimize diffraction effects. Smaller openings (in particular when comparable to the wavelength of the light used to image the opening) are less desirable as they are subject to diffraction effects and these complicate the analysis.

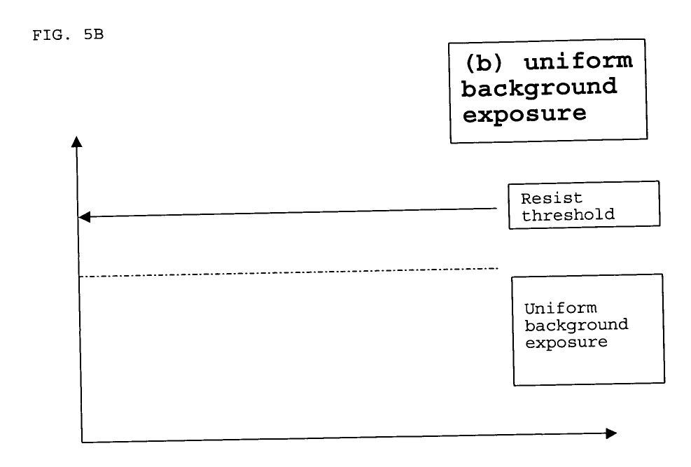

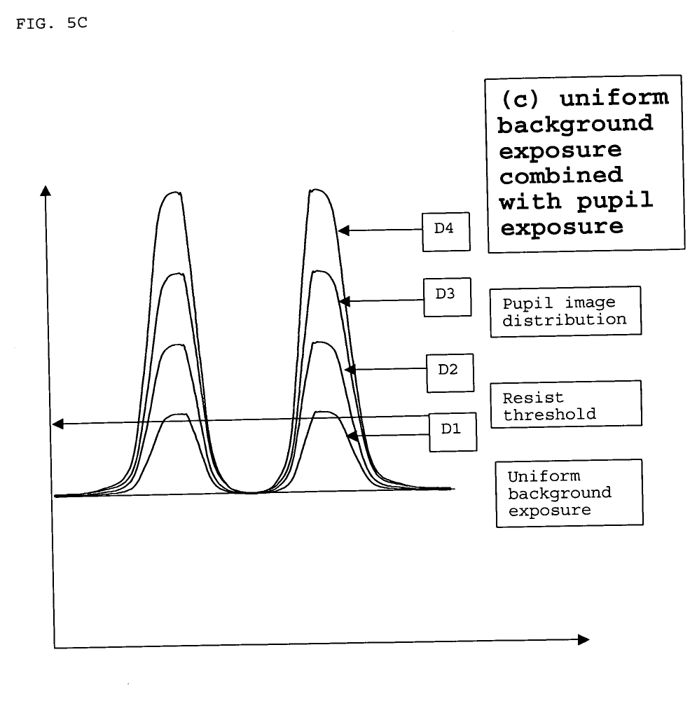

Referring to FIG. 5, two types of exposures are made and superimposed in the same location. This can be achieved by keeping the mask fixed and moving the wafer stage between the first and second exposures by the appropriate amount. In a first step the photoresist detector is exposed using the clear window 11 at a background or primary dose DB below the dose to clear D₀. A second exposure with dose DP is then superimposed onto the first one by imaging one of the small openings 12 at a very large out of focus condition. The out of focus condition is chosen such that the resulting image is representative of the intensity distribution of the illuminator.

First the relationship between off focus imaging and its relationship to the characterization of the pupil illumination will be discussed. Subsequently the significance of the first exposure in facilitating the pupil illumination within the constraints of a conventional exposure system is explained. Various embodiments regarding placement of multiple exposures across wafer or across field are described. Next an alternate preferred embodiment whereby the first exposure serves as a reference mark to aid in the analysis of the pupil images is put forth. Again various modifications of the preferred embodiment are discussed where multiple exposures across field, across wafer and at multiple doses are described. The general description will conclude with a section on the extension of this methodology outside of the area of conventional projection lithography.

Reference is now made to FIG. 6 which depicts a mask that may be used for an implementation of one of the preferred embodiments. As is known in the art exposure of the resist detector with one of the mask patterns 12 and the resist detector kept at best focus results in an image on the wafer that essentially resembles the pattern on the mask, in particular if the feature 12 is large compared to the wavelength of light used for imaging.

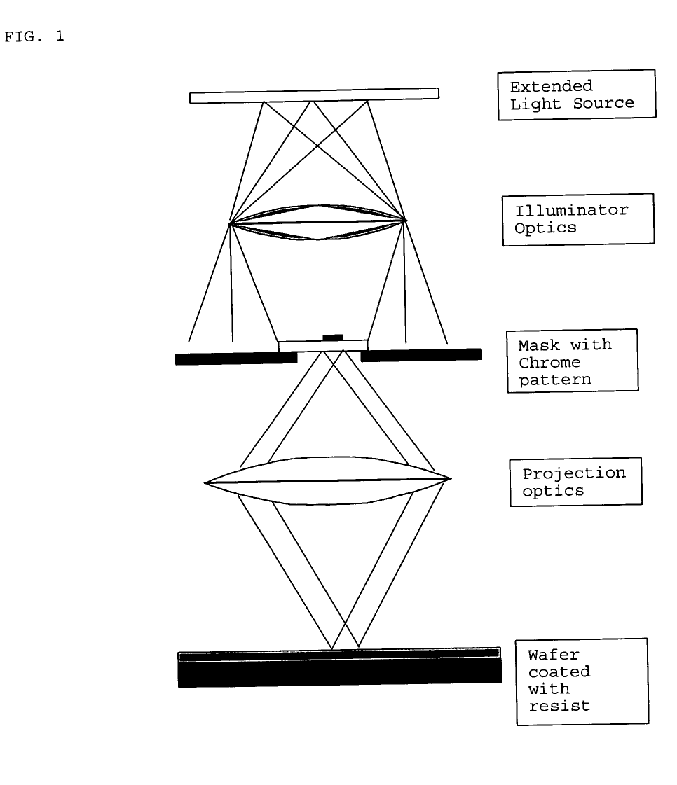

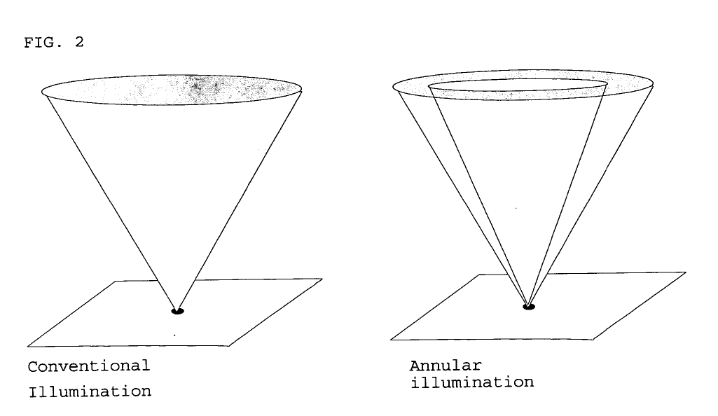

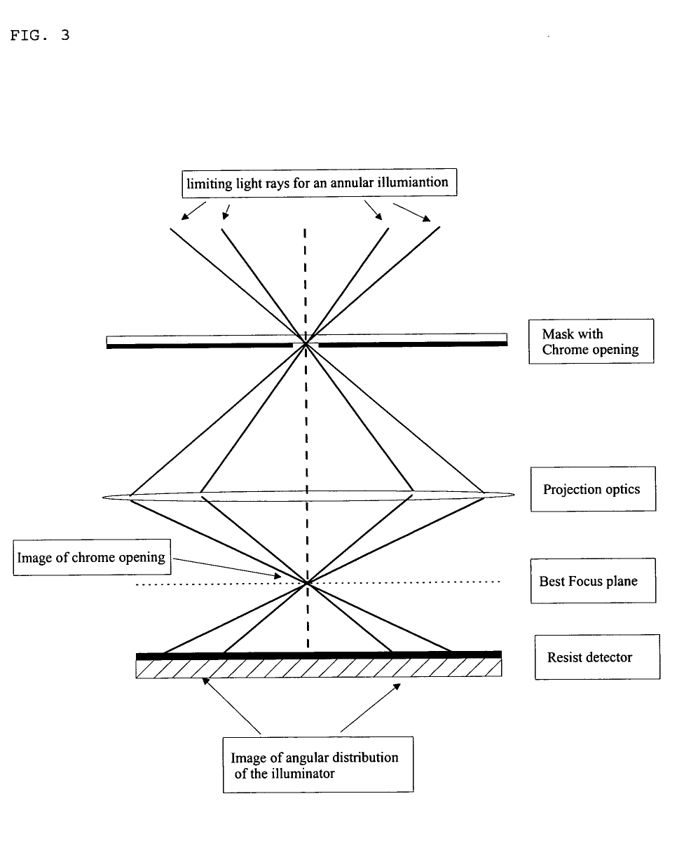

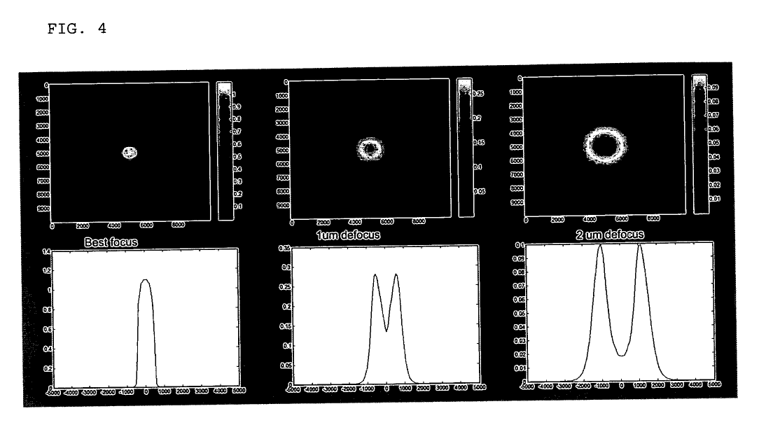

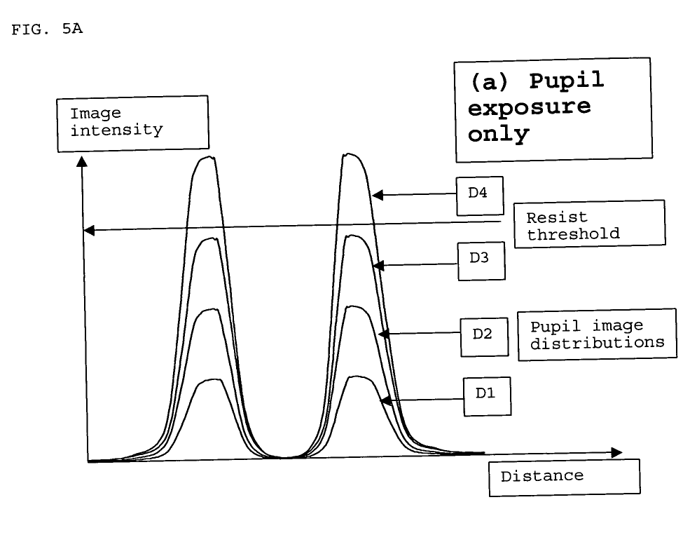

Referring now to FIG. 4, the significance of the off-focus imaging for obtaining images representing the illuminator distribution is explained. FIG. 4 is created using simulated wafer images, a technique well established in the art. We assume an imaging system as schematically depicted in FIG. 1 and an illuminator pattern as shown on the right side of FIG. 2, namely annular illumination. The simulations have been performed for an exposure tool using light at 193 nm, a numerical aperture of 0.75 and annular illumination with 0.5 inner sigma and 0.85 outer sigma. The top row of images shows the aerial image distributions in a grayscale representation as they appear on the wafer. The bottom row represents a series of graphs where the intensity for a cutline through the center of the images above is plotted. The parameter that is varied in moving from the left through the middle to the right graph is the defocus distance. The leftmost image is for best focus (defocus=0). As mentioned above the image at this defocus distance is essentially identical to the mask image (a 1 um circular feature). With increasing defocus distance, we observe the formation of an annulus reminiscent of the illumination pattern used. The sequence highlights the fact that as the defocus amount (i.e. the amount by which the wafer is moved away from the best image plane) increases, the aerial image changes from the image of the opening on the mask (in this case a 1 um opening) at best focus to an image determined by the intensity distribution of the illuminator. However at the same time the relative intensity drops dramatically as the defocus distance decreases. In a single exposure approach very high exposure doses Dₚ (i.e. several 100 mJ/cmˆ2) for the exposure of the transparent mask opening 12 in FIG. 6 are necessary to reach D₀. A preferable off focus distance is approximately 3 to 5 times the diameter of the chrome opening 12. At this off focus condition the image is fairly representative of the illuminator while at the same time still maintains reasonable modulation.

While the discussion so far has mostly focused on the aerial image distributions which are of continuous nature the property that is observed on the wafer is that of a resist pattern. To that extent the resist detector, once exposed is processed through a post exposure bake step and developed to reveal the pattern. These processes may be performed according to techniques known in the field of resist processing.

The exposed and developed wafer reveals a pattern determined by the light distributions that were incident on the resist.

For a given exposure dose a contour will be formed in the resist separating areas that still remain covered by resist from those where the resist has been cleared. FIG. 5a shows a conventional, single exposure approach. Image intensities in the pupil distribution image are low due to the defocus conditions required. In order to form a pattern in resist any part of the image intensities for doses D1 through D4 must lie above the resist threshold. For the particular example shown only dose D4 is sufficient to raise a part of the image intensity above the resist threshold and therefore a pattern is formed in the resist. In those locations where the image intensities are above the threshold the resist is cleared and thus a discernable pattern formed. It is quite common that the exposure doses comparable to the dose D4 in the example are close to or above the dose limits that can be delivered in a single exposure approach on common lithographic tools. Therefore an alternate approach is desirable.

FIGS. 5b and 5c exemplify a preferred embodiment of this invention. FIG. 5b shows the situation after a first, below threshold, uniform dose DB has been delivered. In this case a background intensity has been delivered to the resist. After the second exposure the combined intensity (for the purpose of illustration the same set of doses from FIG. 5a for the second exposure has been used) now allows to observe resist patterns for all four doses DP1 . . . DP4.

These findings can be formulated in a more quantitative fashion. The boundary separating areas where the resist cleared from those where resist remains (in the case of a positive resist) is defined by the condition that the combined dose of background exposure DB and defocused exposure DP of opening 12 is equal to dose to clear D₀. Locations where the combined dose is higher will be completely clear of resist, regions where the combined dose is smaller will remain covered with resist. The boundary is defined by:
DP*illum(x,y)+DB=D₀ (1)
Where DP is the dose used for the off focus exposure, illum(x,y) is the normalized image intensity distribution created by the illuminator in off focus condition and DB the background exposure dose. It should be noted that illum(x,y) is not identical to the intensity distribution of the illuminator but may be calculated from such distributions through simulation techniques as known in the art. Re-arranging Equation (1) as:
DP=(D₀−DB)/illum(x,y) (2)
shows that the secondary exposure dose DP that is needed to measure the pupil distribution is significantly reduced as the primary exposure dose DB₁ approaches the dose to clear D₀ from below. The double exposure method of the present invention reduces the exposure time required to characterize the illuminator distribution as compared to the prior art.

Equation (1) shows that the value of the function illum(x,y) is known at the edge of the developed resist and therefore precise knowledge of the location of this edge is desirable. The boundary can be detected using a variety of techniques including optical microscopy, scanning optical microscopy, atomic force microscopy or SEM microscopy. A preferable implementation is the use of a dark-field optical microscope due to its speed, ease of use and the fact that it produces high contrast images at the resist edge.

The primary goal for reconstructing the illuminator intensity distribution is to derive the function illum(x,y) from a set of contours determined by equation (1). This requires that multiple contours created at multiple doses DB or DP be obtained. Measuring the position of the resist edge for multiple values of the primary exposure dose DB enables mapping out the contour levels of the function illum(x,y). This may be accomplished in two separate ways. In one embodiment the uniform background exposure DB remains constant and a set of contours is obtained by changing the dose DP of the off focus exposure. Alternatively the dose DP may remain constant and the set of contours is retrieved by varying the uniform background exposure DB. Finally it should be mentioned that a combination of both techniques may also be applied.

Referring again to FIG. 6, the set of exposures described above may be accomplished in various ways. In one embodiment, the clear feature 11 is used to expose the resist detector at multiple locations across the resist detector. A different dose DBi (1 . . . i . . . n) is chosen for each exposure. The different locations may be in different exposure fields of the resist detector, such that after each exposure, the wafer stage is stepped to another location on the rectangular grid and another exposure field, adjacent the previous exposure field, is exposed. Alternatively, two or more exposures may be made in the same exposure field of the resist detector at different respective doses. These exposures establish a set of exposure doses DB as defined in equation 1. The pupil generating feature 12 is used to expose the resist detector with a fixed dose DP within the image field defined by mask feature 11 for each of the locations of feature 11. In this manner, multiple image contours are provided, depending on the cumulative exposure dose due to the different background doses Dbi and the uniform pupil dose DP.

In a variation of the process described above, multiple instances 12i (i=1, 2, 3) of the pupil generating feature 12 (see FIG. 6B) are used to expose the detector at a dose DP within the image field defined by the previous exposure of feature 11. This modification allows variations of the pupil illumination as a function of field position to be evaluated. The field position in this case is defined by the location of the mask features 12.

One of the complications arising from placement of the fields 11 across the resist detector is the fact that the value of D₀ may vary across the wafer thus significantly increasing the complexity of the data analysis. This problem can be alleviated through an alternate implementation whereby the spacing between locations of different doses DBi is minimized as described below. In the case of FIG. 6A, the mask includes only one large transparent feature. The mask feature 11 however may be broken up into smaller elements (for example by leaving strips of chrome oriented vertically across the clear opening of feature 11, as shown in FIG. 6C. In this case exposures of the individual elements of feature 11 may be performed by selecting each element using the blading or shuttering capabilities available on most lithography tools. In this case image fields of a multitude of elements 11i may be placed within the exposure field with each one of image fields exposed at a different dose. The pupil generating feature 12 is used to expose the detector within the image fields of elements 11i respectively. As in the case of FIG. 6A, the pupil generating feature 12 may be exposed in each case at the same dose DP, or different doses DPi may be used for the elements 11i respectively. In a further development, multiple pupil generating exposures may be performed at different respective doses in the image field of each element 11i.

Once the image of the illuminator distribution illu(x,y) has been obtained as a series of contours, various approaches may be possible to reconstruct the intensity distribution of the illuminator. An iterative procedure whereby a certain illuminator illumination distribution is assumed and the expected wafer image is calculated and compared to the observed wafer images may be used. The illuminator distribution is then modified and the process repeated until satisfactory agreement between simulated and experimentally observed distributions is achieved.

So far we have assumed that the exposures of the second bright feature are performed at a fixed value of defocus. Closer analysis of the behavior of the distribution illum(x,y) as a function of defocus reveals that additional information useful for the data analysis can be extracted from the dependence of this function on the defocus value. For example, in the case of conventional illumination, tracing the intensity of illum(x,y) in the center of the distribution (x=0, y=0) as a function of defocus reveals a behavior distinctly different from that observed for annular illumination. This difference can be used to facilitate the data analysis.

One of the issues encountered during the data analysis of pupil distributions is the fact that the individual contours need to be superimposed onto each other. To perform this superposition correctly, knowledge of the absolute location of at least one of the points in the image is required. This point then serves as a reference which allows correct superposition. The contours formed in resist may be measured by a variety of techniques as mentioned above. A preferred implementation is the use of dark field microscopy. When capturing the individual image contours, for example in an optical microscope, the stage needs to move from one location to another one and the accuracy of this positioning in most cases is not sufficient to allow proper overlay of the image contours. Having a reference mark in the image circumvents this issue. Capturing the position of the reference mark provides an absolute coordinate for the image captured. Superposition of the pupil images can then simply proceed by ensuring that the reference mark is in the same position in all cases.

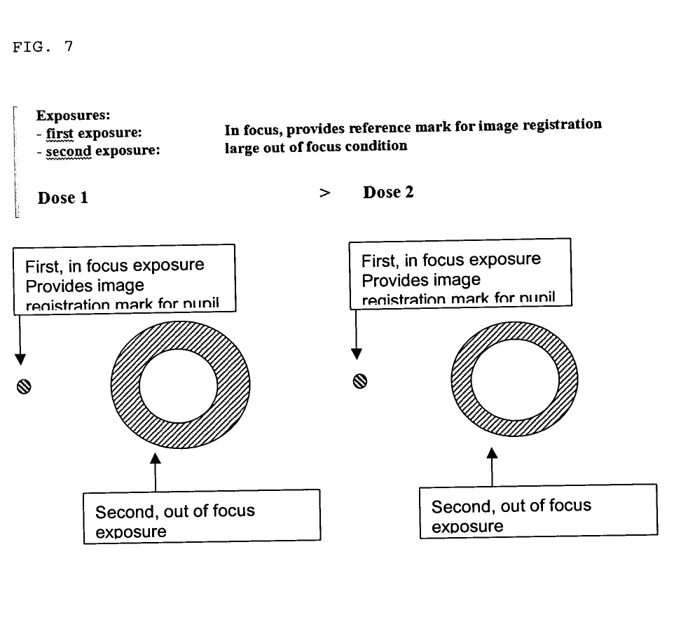

Referring to FIG. 7, a suitable reference mark is created by a first exposure of a bright feature on the mask with a dose larger than D₀. For this exposure the wafer detector is placed in the image plane (i.e. in focus). The wafer detector is then moved both laterally and away from the image plane through movement of the wafer stage and the bright feature on the mask is exposed a second time. Through this off focus placement the image is representative of the illuminator as pointed out in the above discussion. Accordingly, in this development of the invention, after exposure of the detector with the feature 11, the detector is exposed using the feature 12 while the detector is still at the image plane. Then, the detector is moved laterally for the out of focus exposure of feature 12. The left side of FIG. 7 shows schematically the images formed when the out of focus exposure is at a first dose DP1 and the right side of FIG. 7 shows the images when the out of focus exposure is at a second dose DP2, which is less than DP1.

The reference mark is preferably printed at best focus since it then exhibits the minimum lateral shift that may be caused by illuminator misalignment. Larger defocus values are possible but they degrade the ease with which the reference mark can be detected and may also be subject to illuminator induced shifts. Using one reference mark allows us to correct for uniform x-y shifts in the images which is the primary contributor to the positional error. Additional marks or reference structures may be used to correct other positional inaccuracies such as image rotation. In this case the best implementation of the measurement is to use separate bright features for the pupil and the reference mark.

As with the previous preferred embodiment there are a variety of options with respect to the placement of multiple features both across the resist detector (a resist coated wafer) or within the exposure field. In one case multiple instances of the pupil generating pattern 12 may be placed across the image field of feature 11. This type of arrangement allows us to evaluate illuminator distributions in a field location dependent manner. The sequence of dose values necessary to provide a series of contours may be placed across the resist detector. This placement may be performed in a standard fashion where the exposure fields are placed adjacent to each other on a regular chip pattern as is commonly used in the art. The different exposure doses may also be ‘microstepped’. This is a process whereby the exposure fields corresponding to the different doses are not placed adjacent to each other, in non-overlapping relationship, but are shifted by an amount smaller than the size of the field, and in its most useful implementation significantly smaller than the field size, and therefore overlap. A stepsize that could be employed in this embodiment is of the order of 10 um to 1000 um.

Deviations in the illuminator distribution from the ideal shape result in difficulties appropriately modeling the imaging process for example in OPC applications. They may also be an indication of degradation or faulty operation of the exposure tool and can be used to drive corrective action. If they occur across the exposure field they contribute to variations in critical dimensions (CD) across the field. Consequently, the features of the mask are not accurately transferred to the wafer. The techniques described above for measuring illuminator distributions can be used in optical proximity correction (OPC) to reduce variations in CD across the image field and thereby improve image fidelity.

As pointed out in the sections above the characterization of the illuminator distributions may be repeated at a variety of field locations. For example, the field locations can be spaced 2 mm apart along the long dimension of the slit of the stepper-scanner lens. By characterizing the illuminator distribution for a multitude of field points we obtain information that may be used to perform location dependent proximity corrections following methodologies as disclosed in U.S. patent application Ser. No. ______ (Assignee reference invarium ID-015, IA-008), the entire disclosure of which is hereby incorporated by reference herein for all purposes.

It should be noted that the sequence of exposures may be reversed and the time between the two exposures may vary.

The techniques that have been described herein for measuring or characterizing illuminator distributions are not limited to a particular lithography technique and are thus applicable to projection lithography in general.

The actinic radiation may be electromagnetic radiation, such as visible light, UV, EUV, or X-ray radiation, or a particle beam such as an electron beam. The nature of the resist depends on the nature of the actinic radiation, e.g. an electron-beam resist is used in the case of an electron beam imaging system.

Although the invention has been described with reference to a positive photoresist detector, in which the resist clears upon exposure to a clearing dose of actinic radiation, the invention is also applicable to a photoresist detector employing a negative resist, which covers any area when exposed to a covering dose of active radiation.

It will be appreciated that the invention is not restricted to the particular embodiments that have been described, and that variations may be made therein without departing from the scope of the invention as defined in the appended claims and equivalents thereof.

1. A method of measuring pupil intensity distribution of an imaging system having an image plane, said method comprising:
a. providing a radiation detector,
b. exposing an image field of the detector with a bright feature,
c. positioning the detector at a distance away from the image plane,
d. exposing the image field of the detector with a bright feature, resulting in a cumulative exposure of the image field of the detector from at least the exposing steps b and d, and
e. determining a characteristic of a spatial pattern in the cumulative exposure of the image field of the detector.

2. A method according to claim 1, wherein the detector is a resist detector and step b comprises exposing the detector at the image plane.

3. A method according to claim 2, wherein the bright feature recited in step b is a first bright feature, the bright feature recited in step d is a second bright feature that is different from the first bright feature, the imaging system defines an exposure field on the detector and step b comprises exposing the detector at multiple image fields across the exposure field with the first bright feature.

4. A method according the claim 3, wherein the first bright feature has multiple elements.

5. A method according to claim 2, wherein step b comprises exposing multiple image fields across the resist detector with a first bright feature and step d comprises exposing said image fields of the detector with a second bright feature.

6. A method according to claim 2, wherein the bright feature recited in step b is a first bright feature, the bright feature recited in step d is a second bright feature that is different from the first bright feature, the imaging system defines an exposure field on the detector and step d comprises exposing the detector at multiple image fields across the exposure field with the second bright feature.

7. A method according to claim 6, wherein the second bright feature has multiple elements.

8. A method according to claim 7, wherein step d comprises:
d1. exposing the image field of the detector with the second bright feature at a first site and at a first dose, and
d2. exposing the image field of the detector with the second bright feature at a second site and at a second dose.

9. A method according to claim 7, wherein step d comprises:
d1. exposing the image field of the detector with the second bright feature at a first site,
d2. positioning the detector at a different distance away from the image plane from the distance recited in step c, and
d3. exposing the image field of the detector with the second bright feature at a second site.

10. A method according to claim 9, comprising performing the exposures of steps d1 and d3 at first and second doses respectively.

11. a method according to claim 2, wherein step d comprises exposing the image field at multiple sites across the resist detector with said bright feature.

12. A method according to claim 11, comprising performing the multiple exposures of step d at different doses.

13. A method according to claim 11, wherein step d comprises:
d1. exposing the image field of the detector with said bright feature at a first site,
d2. positioning the detector at a different distance away from the image plane from the distance recited in step c, and
d3. exposing the image field of the detector with said bright feature at a second site.

14. A method according to claim 13, comprising performing the exposures of steps d1 and d3 at first and second doses respectively.

15. A method according to claim 2, wherein the bright feature recited in step b is a first bright feature, the bright feature recited in step d is a second bright feature that is different from the first bright feature, the imaging system defines an exposure field on the detector, step b comprises exposing multiple image fields of the detector with a first bright feature, said image fields being distributed across the exposure field, and step d comprises exposing the image fields of the detector with a second bright feature.

16. A method according to claim 15, wherein step d comprises:
d1. exposing a first image field of the detector with said bright feature at a first site and at a first dose, and
d2. exposing said first image field of the detector with said bright feature at a second site and at a second dose.

17. A method according to claim 15, wherein step d comprises:
d1. exposing a first image field of the detector with said bright feature at a first site,
d2. positioning the detector at a different distance away from the image plane from the distance recited in step c, and
d3. exposing said first image field of the detector with said bright feature at a second site.

18. A method according to claim 17, comprising performing the exposures of steps d1 and d3 at first and second doses respectively.

19. A method according to claim 2, wherein step b comprises exposing multiple image fields across the resist detector with a first bright feature, and step d comprises exposing at least first and second image fields of the detector with a second bright feature at multiple sites across the respective image fields.

20. A method according to claim 19, wherein step d comprises:
d1. exposing the first image field of the detector with said second bright feature at a first site and at a first dose, and
d2. exposing the first image field of the detector with said second bright feature at a second site and at a second dose.

21. A method according to claim 19, wherein step d comprises:
d1. exposing the first image field of the detector with said second bright feature at a first site,
d2. positioning the detector at a different distance away from the image plane from the distance recited in step c, and
d3. exposing the image field of the detector with said second bright feature at a second site.

22. A method according to claim 21, comprising performing the exposures of steps d1 and d3 at first and second doses respectively.

23. A method according to claim 1, comprising detecting the spatial pattern of step e using an electron microscope, optical microscope or scanning optical microscope.

24. a method according to claim 3, comprising using the field dependent pupil information as input to perform location dependent OPC correction.

25. A method according to claim 2, wherein the bright features of steps b and d are identical.

26. A method according to claim 25, wherein the imaging system defines an exposure field on the detector, step b comprises exposing the image field of the detector at multiple sites across the exposure field with said bright feature, and step d comprises exposing the image field of the detector at multiple sites across the exposure field with said bright feature.

27. A method according to claim 26, wherein the multiple exposures of step b and d comprise a combination of across field exposures and exposures across the resist detector.

28. A method according to claim 27, wherein the multiple exposures of step d are performed at a variety of dose and defocus values.

29. A method according to claim 26, comprising using information derived from step e as input to a location dependent OPC correction algorithm.

30. A method of measuring pupil intensity distribution of an imaging system having an image plane, said method comprising:
a. providing a radiation detector that includes a resist that changes state of coverage upon exposure to radiation with a dose larger than D₀,
b. positioning the detector at the image plane of the imaging system,
c. exposing a first region of the detector to a radiation dose DB, wherein DB is less than D₀,
d. positioning the detector at a predetermined distance away from the image plane,
e. exposing a second region of the detector to a dose DP of radiation emanating from a bright feature of an exposure mask, wherein the first and second regions of the detector overlap,
f. developing the resist detector, and
g. determining a characteristic of a spatial pattern revealed by step f.

31. A method according to claim 30, wherein step c comprises exposing multiple sites of the detector to respective radiation doses DB1 . . . DBn, where DBi (1<=i<=n) is less than D₀.

32. A method according to claim 31 wherein step e comprises exposing multiple sites across the detector.

33. A method according to claim 30, wherein the second region is within the first region.

34. A method according to claim 30, wherein the bright feature recited in step e has multiple elements and step e comprises exposing the resist detector with said elements of the bright feature distributed across an exposure field.

35. A method according to claim 30, wherein the imaging system defines an exposure field on the detector and step e comprises exposing the detector at multiple sites across the exposure field at different respective dose values.

36. A method according to claim 30, wherein the imaging system defines an exposure field on the detector and step e comprises exposing the detector at multiple across the exposure field at different respective dose values and at a plurality of distances away from the image plane.

37. A method according to claim 36, wherein the bright feature recited in step e has multiple elements and step e comprises exposing the resist detector with said elements of the bright feature distributed across the exposure field.

38. A method according to claim 30, comprising detecting a resist edge using an electron microscope, optical microscope or scanning optical microscope.

39. A method according to claim 34, comprising using the field dependent information to perform field dependent OPC correction.
